(19) United States
(12) Patent Application Publication
(10) Pub. No.: US 2014/0211507 A1
(43) Pub. Date: Jul. 31, 2014

(54) ELECTRONIC DEVICE

(71) Applicants: INNOCOM TECHNOLOGY (SHENZHEN) CO., LTD., Guangdong Province (CN); INNOLUX CORPORATION, Miao-Li County (TW)

(72) Inventor: Jef Notermans, Miao-Li County (TW)

(73) Assignees: INNOLUX CORPORATION, Miao-Li County (TW); INNOCOM TECHNOLOGY (SHENZHEN) CO., LTD., Guangdong Province (TW)

(21) Appl. No.: 13/756,323

(22) Filed: Jan. 31, 2013

(51) Int. Cl. F21V 8/00

(52) U.S. Cl. CPC G02B 6/0088
USPC 362/615; 362/97.1

(57) ABSTRACT

An electronic device is provided. The electronic device includes a cover window, a cover frame, a display module, a backlight module, a light absorbing portion and a light reflecting portion. The cover frame is connected to the cover window, wherein the cover frame is perpendicular to the cover window. The display module is covered by the cover window and the cover frame, wherein the display module faces to the cover window. The backlight module is covered by the cover window and the cover frame, wherein the backlight module faces to the display module. The light absorbing portion is disposed on the cover frame and corresponding to the display module. The light reflecting portion is disposed on the cover frame and corresponding to the backlight module.

### BACKGROUND

1. Field

The present invention relates to an electronic device, and in particular, relates to a portable electronic device with a screen.

2. Description of the Related Art

Further reduction in mobile device dead borders (the distance between the active area of a display element and the edge of the mobile device) by original equipment manufacturers has become difficult. By making the display module dead borders (the distance between active area of the display element and edge of the display element) as small as possible, there is a small success on this. Currently, from an economic standpoint, the smallest size for mobile device dead borders is about 6.5 mm.

### BRIEF SUMMARY

In an embodiment, an electronic device is provided. The electronic device includes a cover window, a cover frame, a display module, a backlight module, a light absorbing portion and a light reflecting portion. The cover frame is connected to the cover window, wherein the cover frame is perpendicular to the cover window. The display module is covered by the cover window and the cover frame, wherein the display module faces to the cover window. The backlight module is covered by the cover window and the cover frame, wherein the backlight module faces to the display module. The light absorbing portion is disposed on the cover frame and corresponding to the display module. The light reflecting portion is disposed on the cover frame and corresponding to the backlight module.

Utilizing the electronic device of the embodiment of the invention, a frame part which is separated from the cover window for supporting the display module is omitted, and a backlight casing which is separated from the cover window for supporting the backlight module is omitted. The display module and the backlight module are fixed by glue. Therefore, the dead border can be reduced to 1 mm-3 mm, further reducing the dimensions of electronic devices.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an electronic device according to a first embodiment of the invention;

FIGS. 2A-2F show electronic devices according to second embodiments of the invention; and

FIG. 3 shows an electronic device according to a third embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

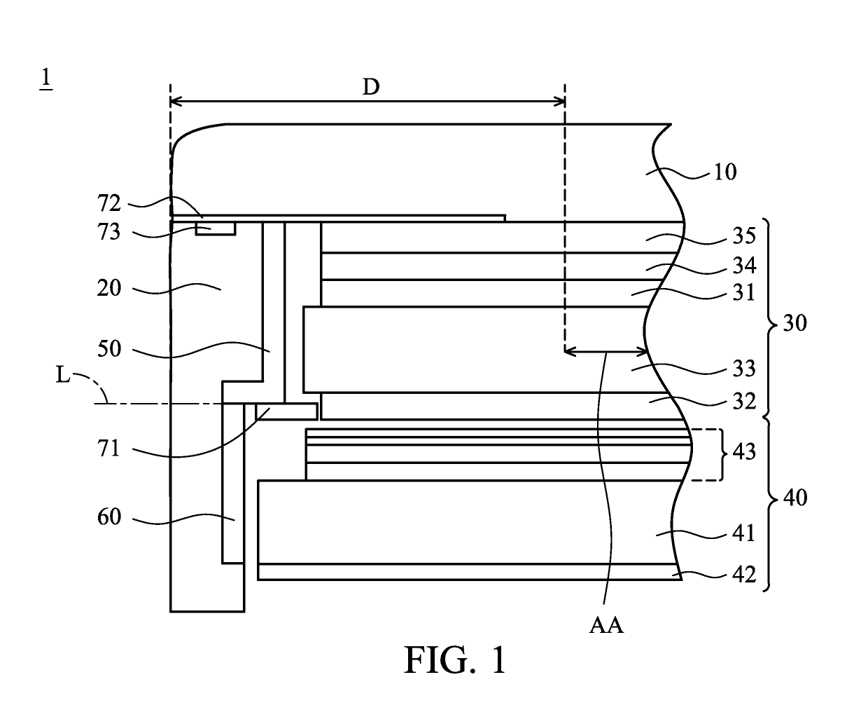

FIG. 1 shows an electronic device 1 of a first embodiment of the invention, which comprises a cover window 10, a cover frame 20, a display module 30, a backlight module 40, a light absorbing portion 50 and a light reflecting portion 60. The cover frame 20 is connected to the cover window 10, wherein the cover frame 20 is perpendicular to the cover window 10. The display module 30 is covered by the cover window 10 and the cover frame 20, wherein the display module 30 faces to the cover window 10. The backlight module 40 is covered by the cover window 10 and the cover frame 20, wherein the backlight module 40 faces to the display module 30. The light absorbing portion 50 is disposed on the cover frame 20 and corresponding to the display module 30. The light reflecting portion 60 is disposed on the cover frame 20 and corresponding to the backlight module 40. The light absorbing portion 50 is to reduce the leakage light from the display module 30 and the backlight module 40 which could improve the contrast ratio. The light reflecting portion 60 is to reflect the light back to the backlight module 40 which could improve the brightness.

The display module 30 comprises a first polarizer film 31, a second polarizer film 32 and a display element 33, wherein the display element 33 is sandwiched between the first polarizer film 31 and the second polarizer film 32, and the second polarizer film 32 is sandwiched between the display element 33 and the backlight module 40. In one embodiment, a boundary line L between the light absorbing portion 50 and the light reflecting portion 60 is corresponding to the second polarizer film 32.

In this embodiment, the display module 30 further comprises a laminated layer 34 and a functional film 35, and the laminated layer 34 and the functional film 35 are sandwiched between the first polarizer film 31 and the cover window 10, and the laminated layer 34 is sandwiched between the first polarizer film 31 and the functional film 35. The functional film 35 can be a polarizer film or anti splinter film for touch screen. The laminated layer 34 can be an optical clear resin (OCR) or optical clear adhesive (OCA) for lamination.

In this embodiment, the display module 30 further comprises touch function which could be achieved by integrated touch sensors on top of the display element 33 (on-cell touch), integrated touch sensors in the display element 33 (in-cell touch), partially integrated touch sensors on top of the display element 33 and partially integrated touch sensors in the display element 33 (hybrid touch), integrated touch sensors on the cover window 10, or disposed a touch panel between the cover window 10 and the first polarizer film 31.

In this embodiment, the backlight module 40 comprises a light guide 41, a reflector film 42 and a plurality of optical films 43, wherein the light guide 41 is sandwiched between the optical films 43 and the reflector film 42, and the optical films 43 are sandwiched between the light guide 41 and the second polarizer film 32.

In this embodiment, the light absorbing portion 50 is black and the light reflecting portion 60 is white. The light absorbing portion 50 and the light reflecting portion 60 can be made of plastic or other materials, and are attached on the cover frame 20. In one embodiment, the light absorbing portion 50 and the light reflecting portion 60 are integrally formed with the cover frame 20.

In this embodiment, the electronic device 1 further comprises a shielding tape 71, wherein the light absorbing portion 50 is L-shaped, and the shielding tape 71 is attached to at least a portion of the light absorbing portion 50. The shielding tape 71 is parallel to the second polarizer film 32. In one embodiment, the shielding tape 71 and the second polarizer film 32 are located on a same plane. In a modified example, the shielding tape 71 abuts the optical film 43. In another modified example, the optical film 43 can be adhered to the shielding tape 71.

In this embodiment, the cover frame 20 is adhered to the cover window 10 via glue 73. The display module 30 is also adhered to the cover window 10 via glue 73.

In this embodiment, a screen print 72 is placed on the bottom side of the cover window 10 to shield the traces on the border and use for decoration.

Utilizing the electronic device 1 of the first embodiment of the invention, a frame part which is separated from the cover window for supporting the display module is omitted, and a backlight casing which is separated from the cover window for supporting the backlight module is omitted. The display module and the backlight module are fixed by glue. Therefore, the width of dead border D (distance between the outer surface of the cover frame 20 and the active area AA of the display element 33) can be reduced to 2.9 mm, to further reduce the dimensions of the electronic device 1.

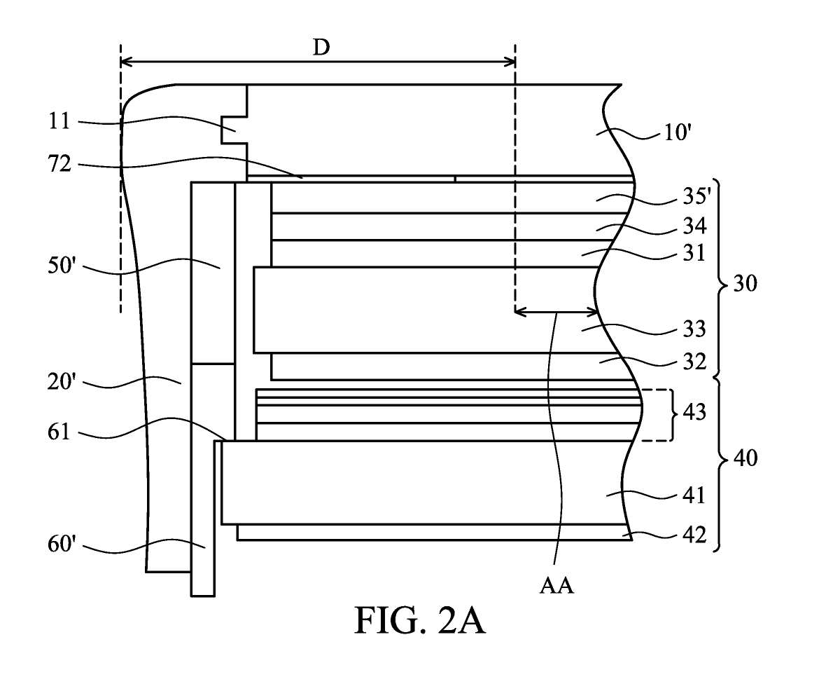

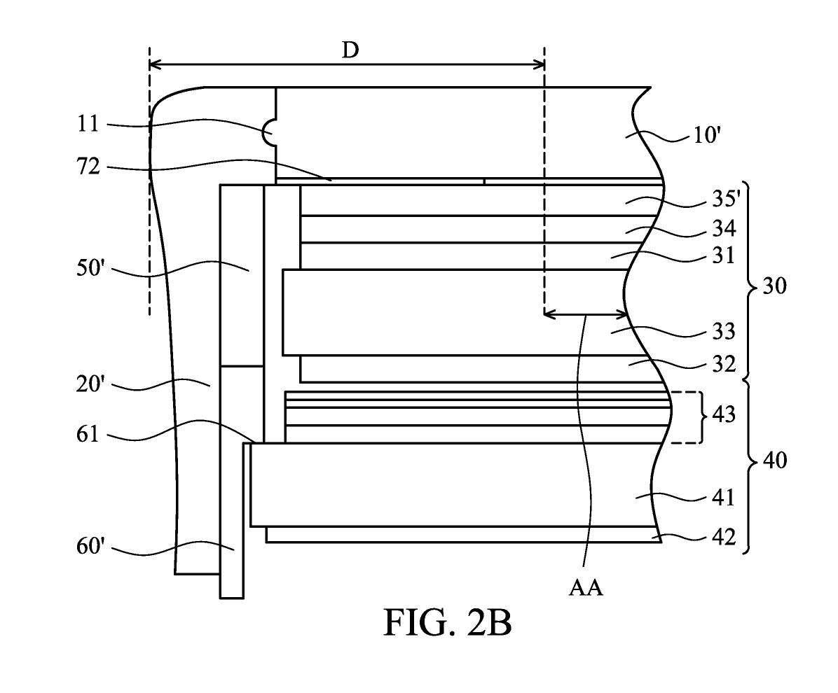

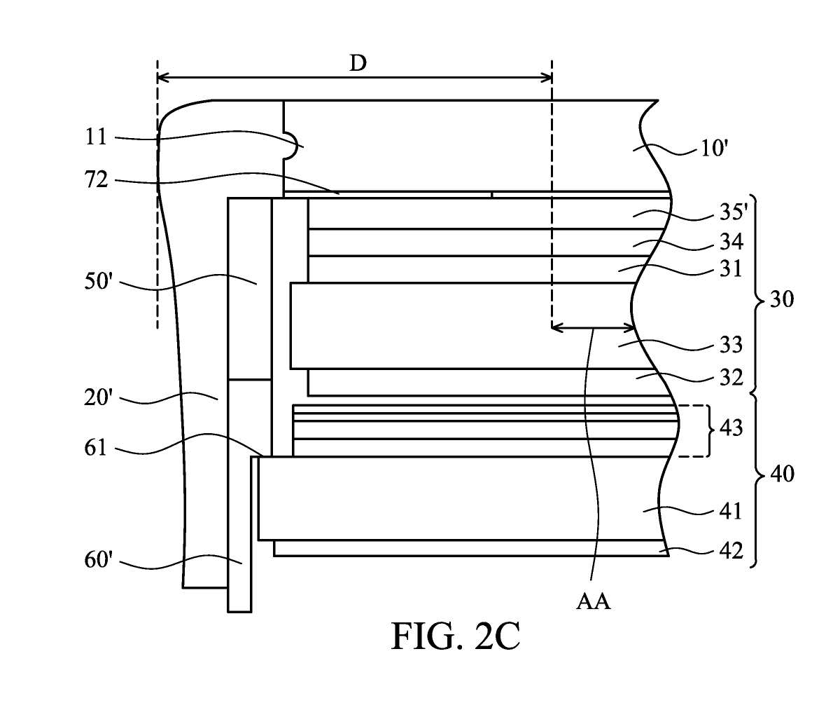

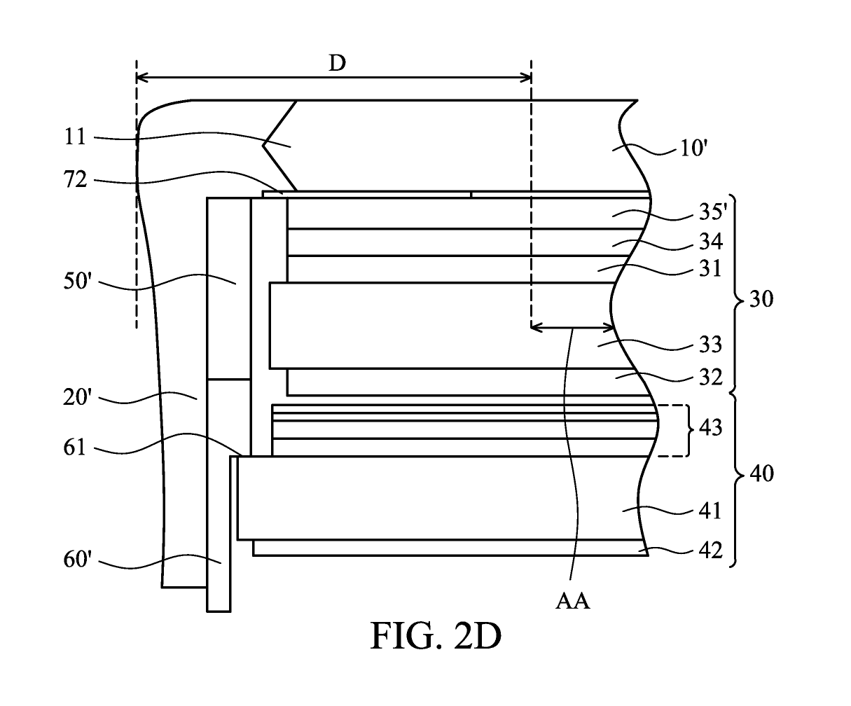

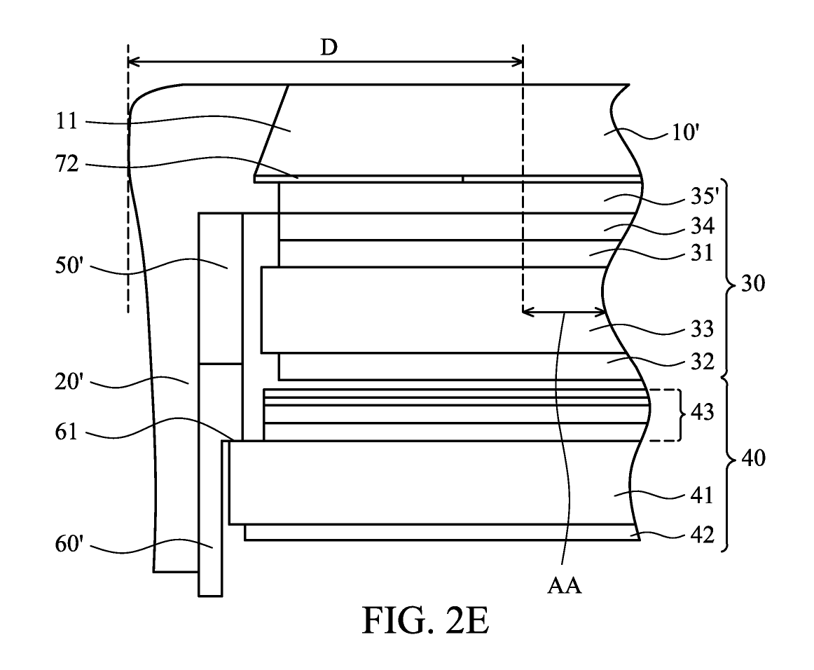

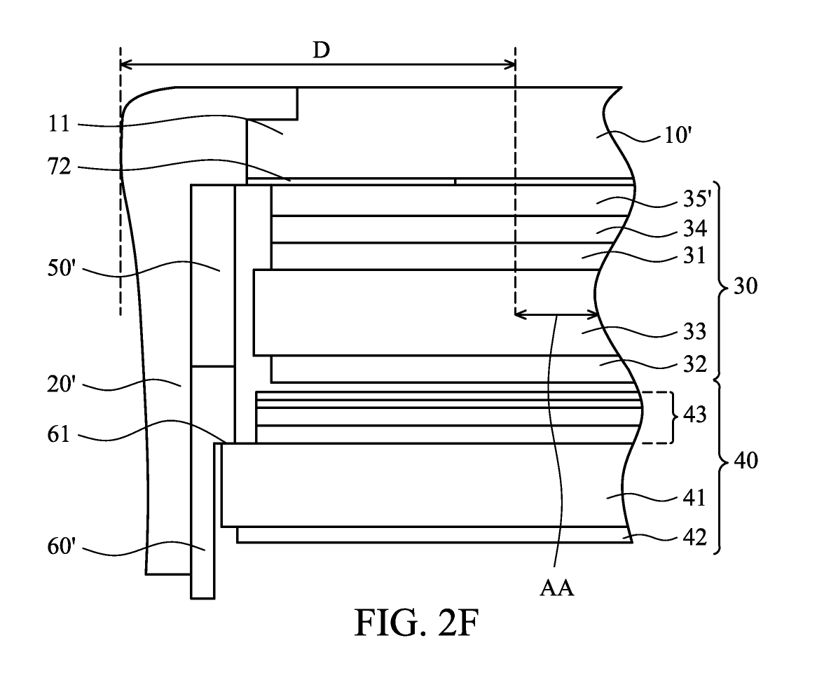

FIG. 2A-2F shows an electronic device of a second embodiment of the invention, wherein the cover window 10′ wedges the cover frame 20′ with a wedging portion 11. The wedging portion 11 can be a protrusion (FIG. 2B) or recess (FIG. 2C), and the wedging portion 11 can also be semicircular (FIGS. 2B and 2C), triangular (FIGS. 2D and 2E), L shaped (FIG. 2F) or other shaped. The light absorbing portion 50′ is longitudinal. The light reflecting portion 60′ has an abutting portion 61, and the abutting portion 61 abuts the light guide 41. In a modified example, the light guide 41 is adhered to the abutting portion 61. In the second embodiment of the invention, the width of dead border D can be reduced to less than 2.2 mm.

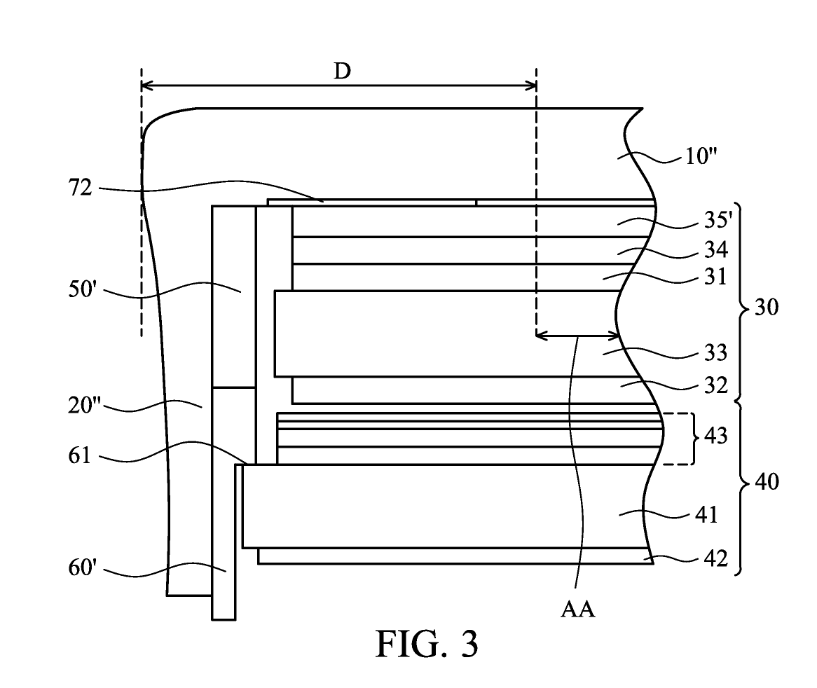

FIG. 3 shows an electronic device of a third embodiment of the invention, wherein the cover window 10″ is integrally formed with the cover frame 20″. In the third embodiment of the invention, the dead border D can be further reduced.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a cover window;
a cover frame, connected to the cover window, wherein the cover frame is perpendicular to the cover window;
a display module, covered by the cover window and the cover frame, wherein the display module faces to the cover window;
a backlight module, covered by the cover window and the cover frame, wherein the backlight module faces to the display module;
a light absorbing portion, disposed on the cover frame and corresponding to the display module; and
a light reflecting portion, disposed on the cover frame and corresponding to the backlight module.

2. The electronic device as claimed in claim 1, wherein the cover window is wedged or adhered to the cover frame.

3. The electronic device as claimed in claim 1, wherein the cover window and the cover frame are integrally formed.

4. The electronic device as claimed in claim 1, wherein the display module is adhered to the cover window.

5. The electronic device as claimed in claim 1, wherein the light absorbing portion is black and the light reflecting portion is white.

6. The electronic device as claimed in claim 1, wherein the light absorbing portion and the light reflecting portion are integrally formed with the cover frame.

7. The electronic device as claimed in claim 1, wherein the backlight module comprises a light guide, and the light reflecting portion comprises an abutting portion, and the abutting portion abuts the light guide.

8. The electronic device as claimed in claim 7, wherein the abutting portion is adhered to the light guide.

9. The electronic device as claimed in claim 1, further comprising a dead border, wherein the width of the dead border is 1 mm-3 mm.

10. The electronic device as claimed in claim 1, wherein the display module comprises a first polarizer film, a second polarizer film and a display element, and the display element is sandwiched between the first polarizer film and the second polarizer film, and the second polarizer film is sandwiched between the display element and the backlight module.

11. The electronic device as claimed in claim 10, further comprising a shielding tape, wherein the light absorbing portion is L-shaped, and the shielding tape is attached to at least a portion of the light absorbing portion.

12. The electronic device as claimed in claim 11, wherein the shielding tape is parallel to the second polarizer film.

13. The electronic device as claimed in claim 12, wherein the shielding tape and the second polarizer film are on a same plane.

14. The electronic device as claimed in claim 10, further comprising a boundary line between the light absorbing portion and the light reflecting portion is corresponding to the second polarizer film.

15. The electronic device as claimed in claim 10, wherein the display module further comprises a laminated layer, and the laminated layer is sandwiched between the first polarizer film and the cover window.

16. The electronic device as claimed in claim 10, wherein the display module further comprises a functional film, and the functional film is sandwiched between the first polarizer film and the cover window, and the functional layer is a polarizer film or an anti splinter film.

17. The electronic device as claimed in claim 10, wherein the backlight module comprises a light guide, a reflector film and at least one optical film, and the light guide is sandwiched between the optical film and the reflector film, and the optical film is sandwiched between the light guide and the second polarizer film.

18. The electronic device as claimed in claim 1, wherein the electronic device has no frame part which is separated from the cover window for supporting the display module.

19. The electronic device as claimed in claim 1, wherein the electronic device has no backlight casing which is separated from the cover window for supporting the backlight module.
